(19) United States
(12) Patent Application Publication
(10) Pub. No.: US 2013/0103878 A1
(43) Pub. Date: Apr. 25, 2013

(54) UNIVERSAL USB CHARGER

(71) Applicants: Lien-Hsun HO, Taipei (TW); Yi-Chang Chou, Taipei (TW); Chun-shih Yi, Taipei (TW)

(72) Inventors: Lien-Hsun HO, Taipei (TW); Yi-Chang Chou, Taipei (TW); Chun-shih Yi, Taipei (TW)

(21) Appl. No.: 13/280,678

(22) Filed: Oct. 25, 2011

(51) Int. Cl. G06F 13/00

(52) U.S. Cl. 710/316

(57) ABSTRACT

A universal USB charger connected to an electronic device stored with a set of preset voltage values has a power supply circuit, a USB interface having a V_{BUS} terminal and a ground terminal respectively connected to a positive DC power terminal and a ground terminal of the power supply circuit, and an output voltage switching module having multiple preset voltage units corresponding to electronic devices of multiple brands and a switching interface connected between the preset voltage units and a D⁺ terminal and a D⁻ terminal of the USB interface. Each preset voltage unit outputs a D⁺ voltage and a D⁻ voltage. The switching interface is operated to output the D⁺ and D⁻ voltages associated with the electronic device through the D⁺ and D⁻ terminals. After determining that the D⁺ and D⁻ voltages match the set of preset voltage values, the electronic device allows itself to be charged by the charger.

### BACKGROUND OF THE INVENTION

1. Field of the Invention

The present invention relates to a USB charger, and more particularly to a universal USB charger.

2. Description of the Related Art

Universal Serial Bus (USB) interface is one of the most prevailing communication interfaces currently. The pin definitions of the USB interface have a V_{BUS} terminal, a D⁺ terminal, a D⁻ terminal and a ground terminal. The V_{BUS} terminal and the ground terminal serve to provide 5V DC voltage. The D⁺ terminal and the D⁻ terminal serve to transmit data. Hence, the USB interface can be used to simultaneously supply DC voltage and transmit data.

Various portable electronic devices, such as MP3 multimedia players, mobile phones and the like, already have the USB interface to communicate with computers for the purpose of data exchange. Since the USB interface also supports power transmission, manufacturers of the portable electronic devices produce chargers having USB interfaces to charge the portable electronic devices. As a result, electronic devices and chargers having all kinds of USB interfaces are available in the market.

As some manufacturers want consumers to purchase whole sets of electronic devices and chargers dedicated to the electronic devices, the electronic devices and their specific chargers are designed as follows. With reference to FIG. 5, an electronic device has a USB interface 70, a charging circuit 71, a control circuit 72 and a switch 73. The USB interface 70 is mounted on the electronic device. The charging circuit 71 serves to charge the electronic device and is electrically connected to the V_{BUS} terminal of the USB interface 70. The control circuit is electrically connected to the D⁺ terminal and the D⁻ terminal of the USB interface 70 and to the switch 73, and has built-in preset voltage values. The preset voltage values include a D⁺ voltage value and a D⁻ voltage value. The switch 73 is connected between the charging circuit 71 and the ground terminal of the USB interface 70 and is closed or opened based on whether the voltage values received by the D⁺ terminal and the D⁻ terminal of the USB interface 70 are identical to the preset D⁺ and D⁻ voltage values. The charger dedicated to the electronic device also has a USB interface 80. The V_{BUS} terminal of the USB interface 80 is connected to a 5V DC power supply and the ground terminal thereof is connected to the ground. The D⁺ terminal and the D⁻ terminal of the USB interface 80 respectively output D⁺ and D⁻ voltage values therethrough. When the control circuit 72 of the electronic device detects the D⁺ and D⁻ voltage values received by the D⁺ terminal and the D⁻ terminal of the USB interface 70 are identical to the preset D⁺ and D⁻ voltage values, the switch 73 is closed so that the V_{BUS} terminal, the ground terminal and the charging circuit 71 constitute a circuit loop and the electronic device is charged through the charging circuit 71. If the USB interface 80 of a non-dedicated charger is connected to the electronic device, the D⁺ and D⁻ voltage values outputted through the D⁺ terminal and the D⁻ terminal of the non-dedicated charger differ from the preset D⁺ and D⁻ voltage values stored in the control circuit 72 so that the control circuit 72 controls the switch 73 to be opened. Thus, the V_{BUS} terminal, the ground terminal and the charging circuit 71 do not constitute a circuit loop and the charging circuit 71 fails to charge the electronic device. Hence, electronic devices should be always charged using the dedicated chargers.

However, to charge all the electronic devices during travel, many different chargers must be carried at the same time. Such charging necessity causes not only inconvenience of portability but also battery drain out making the corresponding electronic devices unexpectedly functionless if dedicated chargers are forgotten.

### SUMMARY OF THE INVENTION

An objective of the present invention is to provide a universal USB charger extensively applicable to electronic devices of different brands.

To achieve the foregoing objective, the universal USB charger serves to charge multiple electronic devices. Each has a USB interface and a charging circuit therein connected to the USB interface and is stored with one set of preset voltage values. The universal USB charger has a power supply circuit, a USB interface and an output voltage switching module.

The power supply circuit has a positive DC power terminal and a ground terminal.

The USB interface has a V_{BUS} terminal, a D⁺ terminal, a D⁻ terminal, and a ground terminal. The V_{BUS} terminal is electrically connected to the positive DC power terminal of the power supply circuit. The ground terminal is electrically connected to the ground terminal of the power supply circuit.

The output voltage switching module has a D⁺ output terminal, a D⁻ output terminal, multiple preset voltage units and a switching interface.

The D⁺ output terminal is connected to the D⁺ terminal of the USB interface. The D⁻ output terminal is connected to the D⁻ terminal of the USB interface. Each preset voltage unit has a high voltage terminal and a low voltage terminal, is adapted to correspond to the set of preset voltage values of a branded electronic device and respectively outputs a D⁺ voltage and a D⁻ voltage through the high voltage terminal and the low voltage terminal in accordance with the set of preset voltage values of the branded electronic device.

The switching interface serves to switch to one of the preset voltage units for the preset voltage unit to output the D⁺ voltage and the D⁻ voltage through the D⁺ output terminal and the D⁻ output terminal.

Given the foregoing technical approach, the voltages outputted from the D⁺ terminal and the D⁻ terminal of the universal USB charger to match the set of preset voltage values stored in a branded electronic device can be easily switched so as to allow the branded electronic device to be charged by the universal USB charger. Accordingly, the universal USB charger can be extensively applied to charge electronic devices of various brands.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a universal USB charger in accordance with the present invention;

FIG. 2 is a functional block diagram of an output voltage switching module of the universal USB charger in FIG. 1;

FIG. 3 is a circuit diagram of a preset voltage unit of the USB charger in FIG. 1;

FIG. 4 is an operational functional block diagram of the USB charger in FIG. 1; and

FIG. 5 is an operational functional block diagram of an electronic device and a conventional charger dedicated to the electronic device.

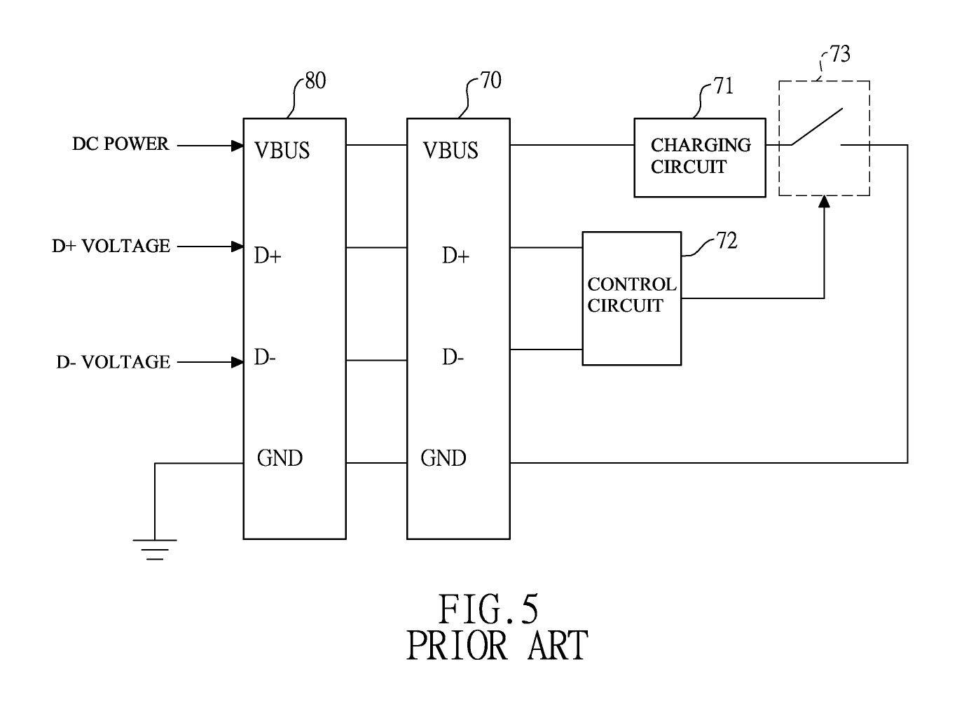

### DETAILED DESCRIPTION OF THE INVENTION

A universal USB charger in accordance with the present invention serves to charge electronic devices of various brands having different sets of preset voltage values embedded therein as the criteria for charger to charge the branded electronic devices.

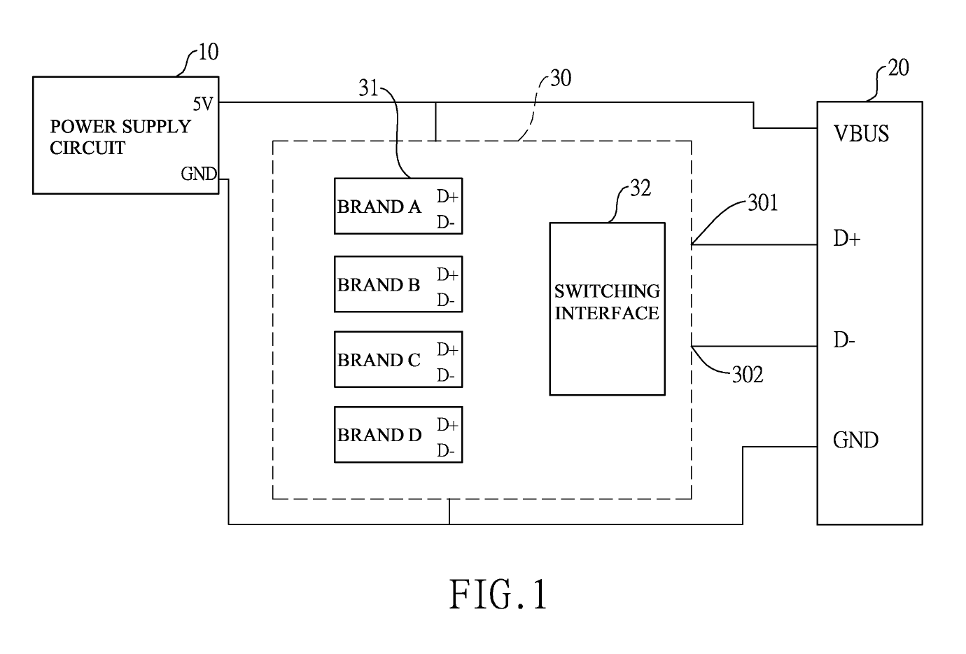

With reference to FIG. 1, a universal USB charger has a power supply circuit 10, a USB interface 20 and an output voltage switching module 30.

The power supply circuit 10 has a positive DC power terminal and a ground terminal. In the present embodiment, the positive DC power terminal is a 5V DC power terminal.

The USB interface 20 has a V_{BUS} terminal, a D⁺ terminal, a D⁻ terminal and a ground terminal. The V_{BUS} terminal is electrically connected to the 5V DC power terminal of the power supply circuit 10, and the ground terminal is electrically connected to the ground terminal of the power supply circuit 10.

The output voltage switching module 30 has a D⁺ output terminal 301 and a D⁻ output terminal 302, multiple preset voltage units 31 and a switching interface 32. The D⁺ output terminal 301 and the D⁻ output terminal 302 are respectively connected to the D⁺ terminal and the D⁻ terminal of the USB interface 20. Each preset voltage unit 31 has a high voltage terminal and a low voltage terminal, corresponds to a branded electronic device and outputs a D⁺ voltage and a D⁻ voltage in accordance with the set of preset voltage values of the branded electronic device. The switching interface 32 switches to one of the preset voltage units 31 based on user's operation and lets the preset voltage unit 31 to output the D⁺ voltage and the D⁻ voltage through the D⁺ output terminal 301 and the D⁻ output terminal 302.

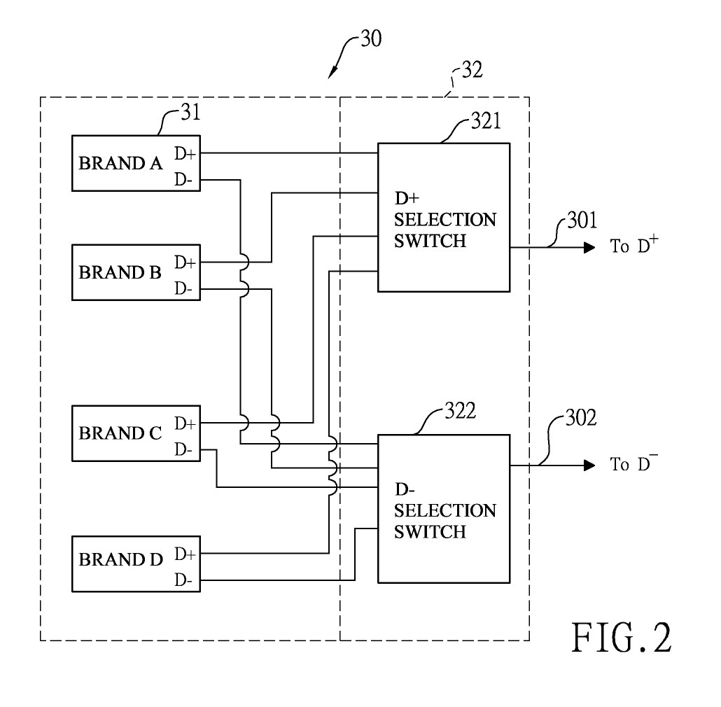

With reference to FIG. 2, the switching interface 32 has a D⁺ selection switch 321 and a D⁻ selection switch 322. In the present embodiment, the switching interface 32 can be implemented by a linked switch. The D⁺ selection switch 321 and the D⁻ selection switch 322 can be jointly operated in accordance with users' operation on the switching interface 32 to respectively output the D⁺ voltage and the D⁻ voltage of a corresponding preset voltage unit. The D⁺ selection switch 321 has multiple input pins and an output pin. The output pin of the D⁺ selection switch 321 is electrically connected to the D⁺ output terminal 301 of the output voltage switching module 30, and the input pins are respectively connected to the preset voltage units 31 to acquire the respective D⁺ voltages of the preset voltage units 31. The D⁻ selection switch 322 has multiple input pins and an output pin. The output pin of the D⁻ selection switch 322 is electrically connected to the D⁻ output terminal 302 of the output voltage switching module 30, and the input pins are respectively connected to the preset voltage units 31 to acquire the respective D⁻ voltages of the preset voltage units 31.

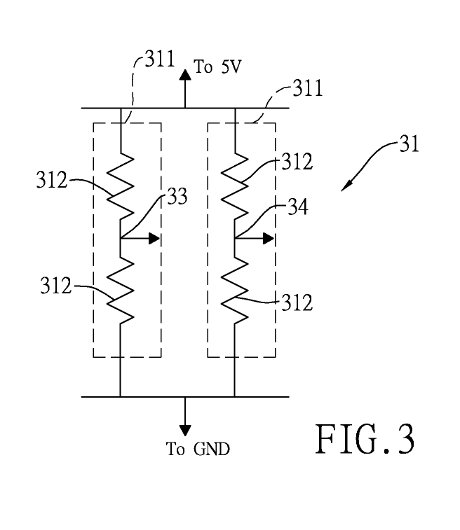

With reference to FIG. 3, each preset voltage unit 31 has two sets of voltage dividers 311. Each voltage divider 311 has two resistors 312 serially connected between the 5V DC power source and the ground terminal of the power supply circuit 10 and a connection node 33, 34 formed between the two resistors 312. The 5V DC power passes through each voltage divider 311 and is divided into two voltage drops across the two resistors 312 of the voltage divider 311. The voltages on the connection nodes 33, 34 of each preset voltage unit are the D⁺ voltage and the D⁻ voltage respectively. The connection nodes 33, 34 are respectively connected to the input pins of the D⁺ selection switch 321 and the D⁻ selection switch 322. Assume that the preset D⁺ voltage value and the preset D⁻ voltage value of a Brand A electronic device are 4.5V and 3.5V respectively. The two resistors 312 of the voltage divider 311 selected to generate the preset D⁺ voltage are 1 KΩ and 9 KΩ with the 1 KΩ resistor connected to the 5V DC power terminal and the 9 KΩ resistor connected to the ground. Hence, the voltage on the connection node 33 between the two serially connected resistors 312 is 4.5V and corresponds to the preset D⁺ voltage of the Brand A electronic device. Similarly, the two resistors 312 of the voltage divider 311 selected to generate the preset D⁻ voltage are 3 KΩ and 7 KΩ with the 3 KΩ resistor connected to the 5V DC power terminal. Hence, the voltage on the connection node 34 between the two serially connected resistors 312 is 3.5V and corresponds to the preset D⁻ voltage of the Brand A electronic device.

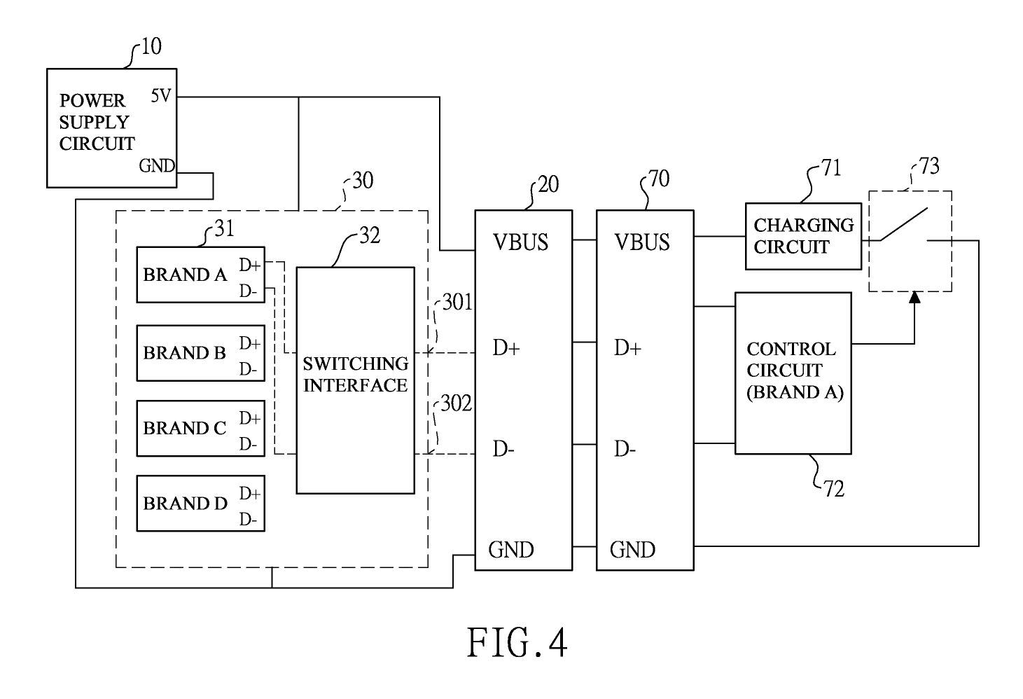

With reference to FIG. 4, when the universal USB charger is operated to charge an electronic device, for example, a Brand A electronic device, users just need to switch the switching interface 32 so that the D⁺ voltage and the D⁻ voltage outputted by a preset voltage unit 31 corresponding to Brand A electronic devices are outputted through the D⁺ terminal and the D⁻ terminal of the USB interface 20. A control circuit 72 in a Brand A electronic device receives the D⁺ voltage and the D⁻ voltage from the D⁺ terminal and the D⁻ terminal of the USB interface 20. After determining that the received D⁺ voltage and the D⁻ voltage match the preset D⁺ voltage value and the preset D⁻ voltage value of the Brand A electronic device, the control circuit 72 controls the switch 73 to be closed so that the 5V DC power source and the ground terminal of the power supply circuit 10 of the charger and the charging circuit 71 of the electronic device constitute a circuit loop formed and the charging circuit 71 can charge the electronic device. Similarly, when the universal USB charger is connected with an electronic device of another brand, users just need to switch the switching interface 32 again so that the D⁺ terminal and the D⁻ terminal of the USB interface 20 output the D⁺ voltage and the D⁻ voltage corresponding to the preset D⁺ voltage value and the preset D⁻ voltage value of the branded electronic device and the branded electronic device allows itself to be charged by the universal USB charger.

The universal USB charger can be extensively applied to charge electronic devices of various brands. Accordingly, users just need to carry one universal USB charger instead of many dedicated USB chargers for charging various electronic devices, thereby significantly lowering users' burden in carrying too many USB chargers.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A universal USB charger serving to charge multiple electronic devices each having a USB interface and a charging circuit therein connected to the USB interface and stored with one set of preset voltage values, the universal USB charger comprising:
a power supply circuit having a positive DC power terminal and a ground terminal;
a USB interface having:
a V_{BUS} terminal electrically connected to the positive DC power terminal of the power supply circuit;
a D⁺ terminal;
a D⁻ terminal; and
a ground terminal electrically connected to the ground terminal of the power supply circuit; and
an output voltage switching module having:
a D⁺ output terminal connected to the D⁺ terminal of the USB interface;
a D⁻ output terminal connected to the D⁻ terminal of the USB interface;
multiple preset voltage units, each preset voltage unit having a high voltage terminal and a low voltage terminal, adapted to correspond to the set of preset voltage values of a branded electronic device and respectively outputting a D⁺ voltage and a D⁻ voltage through the high voltage terminal and the low voltage terminal in accordance with the set of preset voltage values of the branded electronic device; and
a switching interface serving to switch to one of the preset voltage units for the preset voltage unit to output the D⁺ voltage and the D⁻ voltage through the D⁺ output terminal and the D⁻ output terminal.

2. The universal USB charger as claimed in claim 1, wherein
the switching interface has a D⁺ selection switch and a D⁻ selection switch; the D⁺ selection switch has multiple input pins and an output pin, the output pin of the D⁺ selection switch is electrically connected to the D⁺ output terminal of the output voltage switching module and the input pins are respectively connected to the high voltage terminals of the preset voltage units to acquire the respective D⁺ voltages of the preset voltage units;
the D⁻ selection switch has multiple input pins and an output pin, the output pin of the D⁻ selection switch is electrically connected to the D⁻ output terminal of the output voltage switching module and the input pins are respectively connected to the low voltage terminals of the preset voltage units to acquire the respective D⁻ voltages of the preset voltage units.

3. The universal USB charger as claimed in claim 2, wherein the D⁺ selection switch and the D⁻ selection switch are jointly operated in accordance with operation on the switching interface to respectively output the D⁺ voltage and the D⁻ voltage of one of the preset voltage units.

4. The universal USB charger as claimed in claim 1, wherein each preset voltage unit has two sets of voltage dividers, each voltage divider has two resistors serially connected between the positive DC power terminal and the ground terminal of the power supply circuit and a connection node formed between the two resistors, the DC power passes through each voltage divider and is divided into two voltage drops across the two resistors of the voltage divider, the voltages on the two connection nodes of each preset voltage unit are the D⁺ voltage and the D⁻ voltage outputted by the preset voltage unit respectively.

5. The universal USB charger as claimed in claim 2, wherein each preset voltage unit has two sets of voltage dividers, each voltage divider has two resistors serially connected between the positive DC power terminal and the ground terminal of the power supply circuit and a connection node formed between the two resistors, the DC power passes through each voltage divider and is divided into two voltage drops across the two resistors of the voltage divider, the voltages on the two connection nodes of each preset voltage unit are the D⁺ voltage and the D⁻ voltage outputted by the preset voltage unit respectively.

6. The universal USB charger as claimed in claim 3, wherein each preset voltage unit has two sets of voltage dividers, each voltage divider has two resistors serially connected between the positive DC power terminal and the ground terminal of the power supply circuit and a connection node formed between the two resistors, the DC power passes through each voltage divider and is divided into two voltage drops across the two resistors of the voltage divider, the voltages on the two connection nodes of each preset voltage unit are the D⁺ voltage and the D⁻ voltage outputted by the preset voltage unit respectively.

7. The universal USB charger as claimed in claim 4, wherein the positive DC power terminal is a 5V DC power terminal.

8. The universal USB charger as claimed in claim 5, wherein the positive DC power terminal is a 5V DC power terminal.

9. The universal USB charger as claimed in claim 6, wherein the positive DC power terminal is a 5V DC power terminal.
